(19) United States
(12) Patent Application Publication
(10) Pub. No.: US 2025/0094017 A1
(43) Pub. Date: Mar. 20, 2025

(54) METHODS, DEVICES, VEHICLES, MEDIA AND PRODUCTS FOR DISPLAYING APPLICATION ICONS

(71) Applicant: CARIAD (CHINA) CO., LTD., Beijing (CN)

(72) Inventors: Zhongbo JIANG, Beijing (CN); Jianfei CAI, Beijing (CN); Leili CAI, Beijing (CN)

(21) Appl. No.: 18/885,427

(22) Filed: Sep. 13, 2024

(30) Foreign Application Priority Data
Sep. 15, 2023 (CN) 202311198550.4

(51) Int. Cl. G06F 3/04817

(52) U.S. Cl. CPC G06F 3/04817

(57) ABSTRACT

The embodiments of the present disclosure provide a method for displaying application icons, a device, a vehicle, a medium and a product. The method may comprise acquiring scenario information of a scenario where a vehicle-mounted device is in use. The method may further comprise selecting a group of target applications from a plurality of vehicle applications on the vehicle-mounted device and/or a plurality of device applications on a user device on the basis of the scenario information. The user device is connected to the vehicle-mounted device. Also, the method may further comprise displaying, on the vehicle-mounted device, a group of application icons indicating at least a number of applications among the group of target applications. According to the present disclosure, target applications adapted to a current scenario can be dynamically selected from vehicle applications and/or user device applications according to scenario information of a scenario where the vehicle-mounted device is in use, such that icons of applications currently desired can be displayed for a user, facilitating the user triggering the applications, thereby improving the user experience.

### TECHNICAL FIELD

The embodiments of the present disclosure relate to the field of computer technologies, and more particularly, to a method for displaying application icons, a device, a vehicle, a medium and a product.

### BACKGROUND

User devices such as a smart phone, a computer, and a wearable device are now indispensable portable devices in people's lives. The application markets of these user devices provide abundant applications, covering various aspects such as entertainment, work, life and learning. The development of intelligent vehicles in this aspect is relatively lagging, and at the same time is limited by factors, such as journey time and driving safety, and therefore there are very limited applications that are truly used inside the vehicles on a large scale and with a high frequency.

In order to solve the problem that intelligent vehicle applications are not abundant enough, a current practice is to combine or integrate a vehicle-mounted terminal of an intelligent vehicle with a user device, such that an application on the user device can be directly used on the vehicle-mounted terminal under a certain condition, for example, by using a screen projection technology. This brings a considerable degree of convenience, so it is widely used today. However, the current method still has certain problems, and is not intelligent enough.

### SUMMARY

According to exemplary embodiments of the present disclosure, provided is a technical solution for displaying application icons. Target applications adapted to a current scenario can be dynamically selected from vehicle applications and/or user device applications according to scenario information of a scenario where a vehicle-mounted device is in use, such that icons of applications currently desired can be displayed for a user, facilitating the user triggering the applications, being more intelligent.

In a first aspect of the present disclosure, a method for displaying application icons is provided, which may comprise acquiring scenario information of a scenario where a vehicle-mounted device is in use. The method may further comprise selecting a group of target applications from a plurality of vehicle applications on the vehicle-mounted device and/or a plurality of device applications on a user device on the basis of the scenario information. The user device is connected to the vehicle-mounted device. Also, the method may further comprise displaying, on the vehicle-mounted device, a group of application icons indicating at least a number of applications among the group of target applications. By implementing the method provided in the first aspect, target applications adapted to a current scenario can be dynamically selected, such that icons of applications currently desired can be displayed for a user, being more intelligent.

In a second aspect of the present disclosure, an electronic device for displaying application icons is provided. The electronic device comprises: a processor and a memory coupled to the processor, wherein the memory has instructions stored therein, and the instructions, when executed by the electronic device, cause the electronic device to execute the method provided in the first aspect of the present disclosure. By implementing the electronic device provided in the second aspect, target applications adapted to a current scenario can be dynamically selected, such that icons of applications currently desired can be displayed for a user, being more intelligent.

In a third aspect of the present disclosure, a vehicle is provided, which comprises the electronic device provided in the second aspect. By implementing the vehicle provided in the third aspect of the present disclosure, target applications adapted to a current scenario can be dynamically selected, such that icons of applications currently desired can be displayed for a user, being more intelligent.

In a fourth aspect of the disclosure, a computer-readable storage medium is provided, wherein the computer-readable storage medium stores computer-executable instructions which, when executed, cause a computer to execute the method provided in the first aspect. By implementing the computer-readable storage medium provided in the fourth aspect of the present disclosure, target applications adapted to a current scenario can be dynamically selected, such that icons of applications currently desired can be displayed for a user, being more intelligent.

In a fifth aspect of the disclosure, a computer program product is provided, wherein the computer program product is tangibly stored on a computer-readable medium and comprises computer-executable instructions which, when executed, cause a computer to execute the method according to the first aspect of the present disclosure.

It can be seen from the above description that, according to the solutions of various embodiments of the present disclosure, target applications adapted to a current scenario can be dynamically selected, such that icons of applications currently desired can be displayed for a user, being more intelligent. It should be understood that this Summary is provided to introduce a selection of concepts in a simplified form that are further described below in the Detailed Description of the Embodiments. This Summary is not intended to identify key features or essential features of the present disclosure, nor is it intended to limit the scope of the present disclosure.

### BRIEF DESCRIPTION OF THE DRAWINGS

The above and other features, advantages, and aspects of various embodiments of the present disclosure will become more apparent with reference to the following detailed description taken in conjunction with the drawings. In the drawings, the same or similar reference signs denote the same or similar elements, wherein:

FIG. 1 shows an architectural diagram of a system according to some embodiments of the present disclosure;

FIG. 2 shows a schematic diagram of integration according to some embodiments of the present disclosure;

FIG. 3 shows a schematic diagram of selecting applications desired by a user according to some embodiments of the present disclosure;

FIG. 4 shows another schematic diagram of selecting applications desired by a user according to some embodiments of the present disclosure;

FIG. 5 shows an exemplary flowchart of displaying applications according to some embodiments of the present disclosure;

FIG. 6 shows a schematic diagram when an attribute is icon size according to some embodiments of the present disclosure;

FIG. 7 shows a schematic diagram of switch animation differences according to some embodiments of the present disclosure;

FIG. 8 shows a flowchart of displaying application icons according to some embodiments of the present disclosure; and

FIG. 9 shows a schematic structural diagram of a device which can be used to implement the embodiments of the present disclosure.

### DETAILED DESCRIPTION OF THE EMBODIMENTS

The embodiments of the present disclosure will be described below in more detail with reference to the drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and the embodiments of the present disclosure are only for illustrative purposes and are not intended to limit the scope of the present disclosure.

In the description of the embodiments of the present disclosure, the term “including” and the like should be understood as open-ended comprising, that is, “including but not limited to”. The term “based on” should be understood as “based at least in part on”. The term “one embodiment” or “the embodiment” should be understood as “at least one embodiment”. The terms “first”, “second” and the like may refer to different or identical objects. Other explicit and implicit definitions may also be included below.

At present, there is a method in the market for integrating applications of a user device and a vehicle-mounted terminal by means of technologies such as screen projection. For example, the current technology allows for provision of a super desktop on a vehicle-mounted terminal, and by means of support from an operating system layer, applications on all user devices can be integrated onto a desktop of the vehicle-mounted terminal. However, the current desktop integration method does not really take the practicability and constraints of a vehicle-mounted scenario into consideration, but simply moves a multi-screen desktop of a user device to a larger vehicle-mounted screen, and even applications which are not frequently used on the user device are migrated intactly, which brings troubles to practical usage. Therefore, the current method cannot provide a user the applications currently desired to be used, and is not intelligent enough.

The present disclosure provides a method for displaying application icons, a device, a vehicle, a medium and a product. The method comprises acquiring scenario information of a scenario where a vehicle-mounted device is in use. The method may further comprise selecting a group of target applications from a plurality of vehicle applications on the vehicle-mounted device and/or a plurality of device applications on a user device on the basis of the scenario information. The user device is connected to the vehicle-mounted device. Also, the method may further comprise displaying, on the vehicle-mounted device, a group of application icons indicating at least a number of applications among the group of target applications. According to the solutions of the embodiments of the present disclosure, target applications adapted to a current scenario can be dynamically selected from vehicle applications and/or user device applications according to scenario information of a scenario where the vehicle-mounted device is in use, such that icons of applications currently desired can be displayed for a user, facilitating the user triggering the applications, being more intelligent.

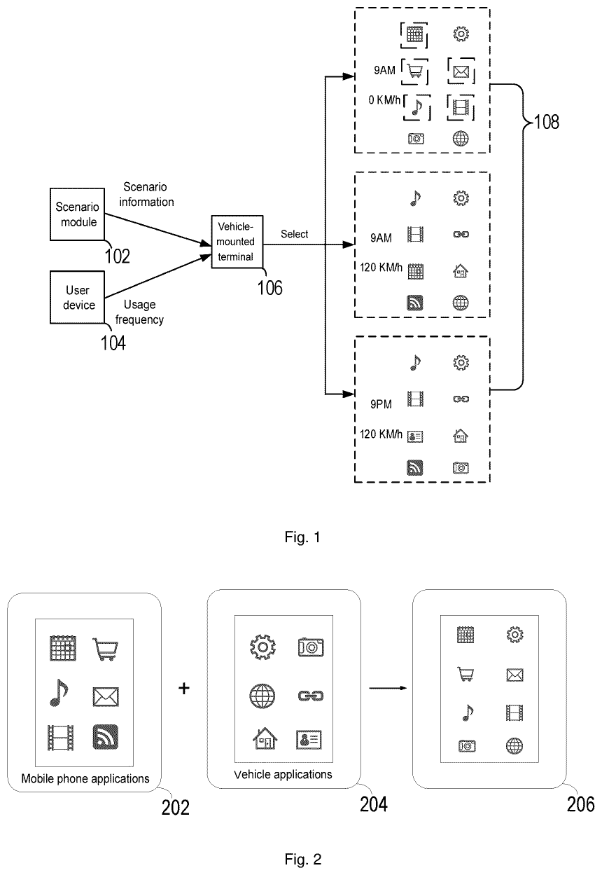

The method provided by the present disclosure will be described below with reference to FIG. 1, and FIG. 2 is a schematic diagram of integration. FIG. 1 shows a system for dynamically adjusting, on the basis of scenario information, application icons displayed on a vehicle-mounted terminal, such that icons of applications (which may also be referred to as target applications) actually desired in a current scenario can be displayed for a user. The system comprises a scenario module 102, a user device 104, and a vehicle-mounted terminal 106 (which may also be referred to as a vehicle-mounted device), wherein the vehicle-mounted terminal 106 may be integrated into a vehicle (not shown). The user device 104 may be different types of devices such as a computer, a wearable device, and a mobile phone. For ease of description herein, a mobile phone is used to serve as the user device 104, but it cannot be construed as a limitation to the present disclosure. The scenario module 102 is used for acquiring current scenario information and providing same to the vehicle-mounted terminal 106, such that the vehicle-mounted terminal 106 can determine, on the basis of the scenario information, applications 206 actually desired by a user in a current scenario from mobile phone applications 202 (which may also be referred to as device applications) on a mobile phone and vehicle applications 204 on the vehicle-mounted terminal, and display icons of these applications for the user to start and/or use the desired applications. It should be noted that, although the scenario module 102 and the vehicle-mounted terminal 106 are shown as two different modules in FIG. 1, the scenario module 102 may also be integrated into the vehicle-mounted terminal 106, that is, the scenario module 102 and the vehicle-mounted terminal 106 are both parts of a vehicle. Although various embodiments where applications 206 actually desired by a user in a current scenario are selected simultaneously from the mobile phone applications 202 and the vehicle applications 204 are described in the description, the method of the embodiments may also be applied to scenarios where the applications 206 actually desired by the user in the current scenario are selected merely from the mobile phone applications 202 and where the applications 206 actually desired by the user in the current scenario are selected merely from the vehicle applications 204. For example, in some examples, the method of any of the following embodiments may be employed to select applications 206 actually desired by the user in the current scenario from the mobile phone applications 202 and display application icons of these applications 206. Alternatively, in other examples, the method of any of the following embodiments may be employed to select applications 206 which are actually desired by the user in the current scenario from the vehicle applications 204 and display application icons of these applications 206. Separate explanations for different scenarios are not given for the sake of simplicity.

In some embodiments, the scenario information acquired by the scenario module 102 may comprise the current time and/or the current speed of a vehicle. In these embodiments, the scenario module 102 may be a clock module and/or a speed meter module. In some embodiments, the vehicle-mounted terminal 106 may query a predetermined mapping table for applications desired by the user on the basis of the obtained scenario information. Exemplarily, a mapping relationship between different scenarios and applications may be pre-configured. For example, in some examples, if the scenario information is the current time, different time periods (for example, time periods of 0 AM to 6 AM, 6 AM to 12 AM, 12 AM to 18 PM, and 18 PM to 0 AM) may be pre-divided, and different time periods are associated with different application sets respectively. It can be understood that a vehicle application and/or a mobile phone application may exist in an application set, which is not described in detail in the following. When the applications desired by the user are determined, the time period to which the current time belongs is determined, and then the applications in the application set associated with the time period are used as the applications desired by the user. Alternatively, in some examples, if the scenario information is the current time, the associated different application sets may also be pre-divided and determined in real time on the basis of whether the current time is a specific date, such as a holiday.

For another example, in some examples, if the scenario information is the current speed, different speed ranges (for example, speed ranges of 0 km/h to 30 km/h, 30 km/h to 60 km/h and above 60 km) may be pre-divided, and different speed ranges are associated with different application sets respectively. When the applications desired by the user are determined, the speed range to which the current speed belongs is determined, and then the applications in the application set associated with the speed range are used as the applications desired by the user. For example, in some other examples, the scenario information may comprise the current time, the current speed, and other information (for example, road condition, weather, etc.) at the same time, and the method for determining the desired applications is similar to that described above and is not repeated herein.

In other embodiments, the vehicle-mounted terminal 106 may automatically determine, on the basis of the obtained scenario information, which applications are applications desired by the user in the current scenario. For example, in some examples, the vehicle-mounted terminal 106 may, upon permission, connect to the Internet to acquire from a developer of each application scenarios where all users of the application use the application, and then automatically select the applications desired by the user in the current scenario on the basis of an acquisition result. It can be understood that automatic determination may also be performed on the basis of other determination methods, and the automatic determination method cannot be taken as a limitation to the present disclosure. By means of an automatic determination method, a configuration which needs to be made by a user in advance can be simplified.

After obtaining the applications 206 desired by the user in the current scenario from the vehicle applications 204 and the mobile phone applications 202, the vehicle-mounted terminal 106 may display, on a display apparatus such as a screen, application icons indicating at least a number of applications among these applications. For example, in some examples, when the icons on the display apparatus can exist on only one display page but cannot be displayed on separate pages, the vehicle-mounted terminal 106 may display an application icon for indicating each application among these applications on the display page of the display apparatus. While in other examples, if the icons on the display apparatus can be displayed on separate pages, the vehicle-mounted terminal 106 may determine the applications displayed on the current display page among these applications and then display the application icons of the applications. When the user switches the page, the application icons for indicating the remaining applications among these applications are displayed. For ease of explanation, all of these applications are hereinafter described as being displayed on only one page. It can be understood that, when the icons on the display apparatus can exist on only one display page but cannot be displayed on separate pages, the vehicle-mounted terminal 106 may also display only the application icons for indicating a number of applications among these applications on the display page of the display apparatus, and the selection standard for said number of applications is, for example, the usage frequency.

Referring back to FIG. 1, FIG. 1 provides a plurality of display page display situations 108 in different scenarios. It can be seen that the application icons displayed in different scenarios are not necessarily the same, and a system may display icons of desired applications for a user on the basis of the requirement of a current scenario. For example, in some examples, for a scenario where the vehicle speed is higher, the user generally does not use applications that require more operations, and therefore icons of applications that require fewer user operations, such as music and videos, may be displayed. For a scenario where the vehicle speed is lower, the user may use applications that require more operations, application icons of shopping, calendar, and other applications may be displayed. In order to make the source of the applications more obvious, in a scenario of 9 AM and 0 km/h, mobile phone applications are shown by a dashed box, the applications without a dashed box are vehicle applications, and other scenarios are not identified.

In some embodiments, the vehicle-mounted device 106 may also dynamically select applications desired by the user in the current scenario on the basis of scenario information, usage frequencies of the applications, and usage modes of the applications at the same time. For example, in some embodiments, the vehicle-mounted terminal 106 may directly acquire the usage frequencies of the mobile phone applications from the mobile phone (the user device 104), and select the desired applications on the basis of the usage frequencies of the mobile phone applications, the usage frequencies of the vehicle applications, the scenario information, and the usage modes of the applications. In other embodiments, the usage frequencies may be obtained by normalizing unadjusted usage frequencies (which may also be referred to as initial usage frequencies in this embodiment), so as to represent the degree of priority between the mobile phone and the vehicle-mounted terminal. Exemplarily, in some embodiments, the vehicle-mounted terminal 106 may first acquire unadjusted usage frequencies of the mobile phone applications from the mobile phone, normalize the unadjusted usage frequencies of the mobile phone applications and the unadjusted usage frequencies of the vehicle applications to obtain the usage frequencies of the mobile phone applications and the vehicle applications, and make a selection on the basis of these usage frequencies.

For example, in some examples, if a mobile phone application is wanted to be preferentially considered, the usage frequency of the mobile phone application may be set to be equal to twice the usage frequency of a vehicle application during normalization. For example, for an unadjusted usage frequency 10 times per day of mobile phone application A and an unadjusted usage frequency 10 times per day of a vehicle application, the normalized usage frequency of mobile phone application A may still be 10 times per day, but the usage frequency of the vehicle application becomes 5 times per day. If a vehicle application is wanted to be preferentially considered, an opposite normalization operation may be performed, which is not repeated. It should be noted that, in some examples, the usage modes of the applications may be divided according to whether the applications mainly receive information or interact with the user. For example, applications such as music, videos, and navigators, which mainly receive information and do not need to interact frequently with the user, may be classified as applications of which the usage modes are passive mode in a usage mode set, and applications such as shopping, searching, and conversation, which need to interact frequently with the user, may be classified as applications of which the usage modes are interactive mode in the usage mode set. Therefore, the usage mode of each application may be selected from a usage mode set comprising a passive mode and an interactive mode.

Moreover, in other embodiments, some usage modes (which may also be referred to as target modes) in the usage mode set may further be subdivided into different usage sub-modes, for example, the passive mode may further be subdivided into a semi-passive sub-mode and a fully-passive sub-mode on the basis of the degree of interaction with the user, such that the vehicle-mounted terminal 106 may update the usage mode before subdivision on the basis of the further subdivided usage sub-modes, so as to finally obtain the usage mode of each application. In consideration of the usage frequencies and the usage modes, the vehicle-mounted terminal 106 may further accurately display icons of desired applications for the user in view of the normal usage situation of the applications and the adaptability of the applications to the current scenario. Alternatively, in some cases, the applications desired by the user may also be selected only on the basis of the scenario information and one of the usage frequencies and the usage modes, and the specific process is not described herein again.

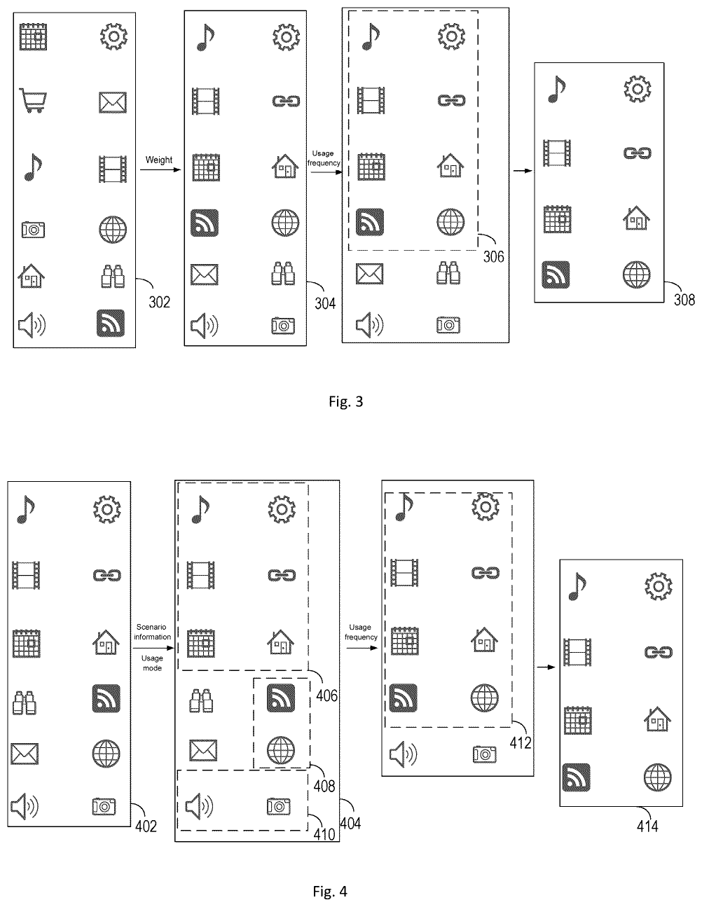

Referring to FIG. 3, FIG. 3 shows a schematic diagram of selecting applications desired by a user on the basis of usage frequencies, usage modes, and scenario information. In some embodiments, the vehicle-mounted terminal 106 may first prioritize 302 all applications on the basis of usage frequencies of vehicle applications and usage frequencies of mobile phone applications, where an application with a higher usage frequency has a higher priority (assuming that the applications therein are shown in the figure in an order of the priorities being higher at the top than at the bottom and higher at the left than at the right, and row ranking taking precedence over column ranking). Then, the vehicle-mounted terminal 106 may determine the weight for adjusting the priority (i.e. the usage frequency) of each application on the basis of the scenario information and the usage mode of each application, and re-prioritize 304 (which may also be referred to as adjusting the usage frequency) the application on the basis of the weight. For example, in some examples, the weight corresponding to the passive mode at a higher speed may be higher, such that the application whose usage mode is the passive mode at the higher speed is determined to be an application which is more desirable to the user in the current scenario. The weight corresponding to the interactive mode at a higher speed may be lower, such that the application whose usage mode is the interactive mode at the higher speed is determined to be an application which is less desirable to the user in the current scenario. Subsequently, the vehicle-mounted terminal 106 may select, on the basis of a precedence relationship between the priorities of the applications (i.e. a magnitude relationship between adjusted usage frequencies), applications with higher priorities as applications 306 desired by the user in the current scenario, and display icons 308 of the applications.

In some embodiments, the weight may further be related to the device to which an application belongs (for example, from the mobile phone or the vehicle-mounted terminal 106). For example, in some examples, considering that a user is unlikely to use a mobile phone application requiring much interaction while driving at high speed, the case with a higher speed, a passive mode, and the device to which an application belongs being the vehicle-mounted terminal 106 may correspond to a higher weight, while the case with a higher speed, a passive mode, and the device to which an application belongs being the mobile phone may correspond to a lower weight. On the contrary, considering that a user may need to use a mobile phone application requiring much interaction when the user stops or the speed is slower, the case with a lower speed, a passive mode, and the device to which an application belongs being the mobile phone may correspond to a higher weight, and the case with a lower speed, a passive mode and the device to which an application belongs being the vehicle-mounted terminal may correspond to a lower weight.

In some embodiments, because the number of applications which can be displayed on the display page of the display apparatus is limited, when the vehicle-mounted terminal 106 selects, on the basis of a precedence relationship between the priorities of the applications (i.e. a magnitude relationship between adjusted usage frequencies), applications with higher priorities as applications 306 desired by the user in the current scenario, applications the number of which does not exceed the allowable number may be selected by a certain selection rule as applications 306 desired by the user. For example, in some examples, the applications having top N highest priorities may be selected as applications 306 desired by the user. Alternatively, for example, in some other examples, the application having priorities (i.e. frequencies) above a predetermined priority threshold (e.g., a predetermined frequency threshold) may be selected as applications 306 desired by the user. In the following description, the applications desired by the user may also be selected on the basis of the method in this embodiment, which is not described herein again for simplicity.

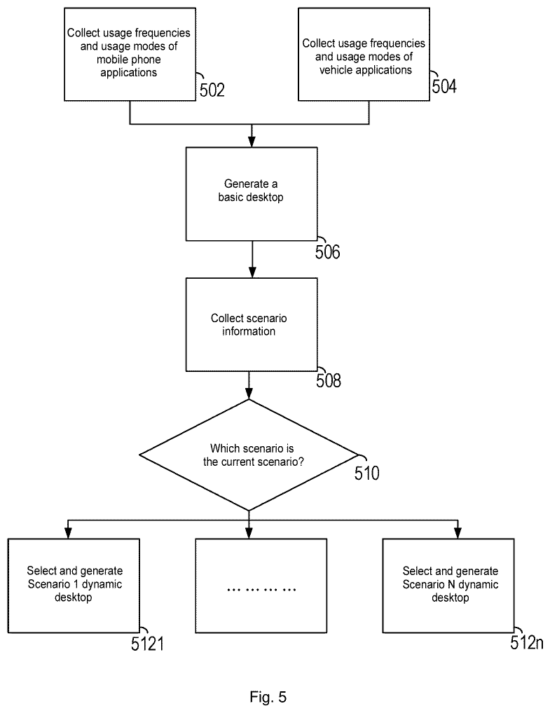

Referring to FIG. 4, FIG. 4 shows another schematic diagram of selecting applications desired by a user on the basis of usage frequencies, usage modes, and scenario information. In some embodiments, a vehicle-mounted terminal 106 may first prioritize 402 all applications on the basis of usage frequencies of vehicle applications and usage frequencies of mobile phone applications, where an application with a higher usage frequency has a higher priority; then, applications 406, 408, and 410 adapted to a current scenario are selected on the basis of scenario information and usage modes of the applications; and then, on the basis of a precedence relationship (i.e. a magnitude relationship between usage frequencies) between the priorities of the selected applications (which may also be referred to as candidate applications), applications which have higher priorities and are frequently used by a user in daily life are selected as applications 412 desired by the user in the current scenario, and icons 414 of the applications are displayed.

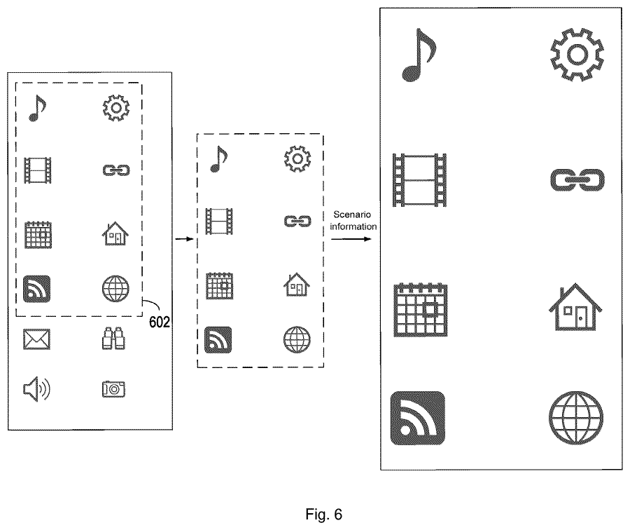

For ease of understanding, an exemplary flowchart of the foregoing process is shown in FIG. 5. At blocks 502 and 504, a vehicle-mounted terminal 106 may acquire usage frequencies and usage modes of mobile phone applications from a mobile phone, and acquire usage frequencies and usage modes of vehicle applications. At block 506, the vehicle-mounted terminal 106 may generate a basic ranking on the basis of the usage frequencies of different applications, wherein the applications are ranked in the basic ranking according to priorities determined on the basis of the usage frequencies. At block 508, the vehicle terminal 106 may acquire scenario information from a scenario module 102. It should be noted that the order between block 508 and blocks 502-506 in FIG. 5 is merely illustrative, and should not be construed as a limitation to the present disclosure. For example, block 508 may be executed first, and then blocks 502-506 are executed. Then, at block 510, the vehicle-mounted terminal 106 determines, on the basis of the scenario information, which scenario the current scenario is, then selects, on the basis of the determined scenario, applications desired by a user in the current scenario according to the usage modes and the priorities, and generates one of dynamic desktops 5121-512n corresponding to the scenario. It can be understood that icons of at least some applications among the applications desired by the user are displayed in the generated dynamic desktop.

In some embodiments, attributes of icons displayed in the dynamic desktop may be related to the scenario information. Referring to FIG. 6, FIG. 6 shows a display situation where an attribute is icon size. The purpose of changing the size of the icon is to enable a user to trigger the desired applications conveniently in different scenarios. For example, in some embodiments, the speed may be proportional to the icon size, such that applications 602 desired by the user can be displayed in a larger icon size during high-speed driving, and therefore the user can trigger the desired applications without much attention. In addition to icon size, the attributes may comprise brightness and background color of icon display, etc. For example, in some embodiments, the display brightness of icons at night may be lower in order to avoid causing discomfort to the user's eyes, while the display brightness of icons during the day may be higher in order to avoid ensure that the icons are clearly visible to the user.

As can be appreciated, when the scenario information changes, for example, when time reaches another time period or speed reaches another speed range, the applications desired by the user may change, and thus the vehicle-mounted terminal 106 may display icons of different applications. Taking the display situation 108 in FIG. 1 as an example, when the speed changes from 0 km/h to 120 km/h, priorities of applications which do not require frequent interaction, such as music and videos, are increased, and new applications which are not selected as applications desired by the user in the scenario of 0 km/h are displayed, such that the group of icons displayed in the scenario of 9 AM and 0 km/h is switched to another group of icons corresponding to the scenario of 9 AM and 120 km/h. When the time changes from 9 AM to 9 PM, new applications which are not selected as applications desired by the user in the scenario of 9 AM are displayed, such that the group of icons displayed in the scenario of 9 AM and 120 km/h is switched to another group of icons corresponding to the scenario of 9 PM and 120km/h.

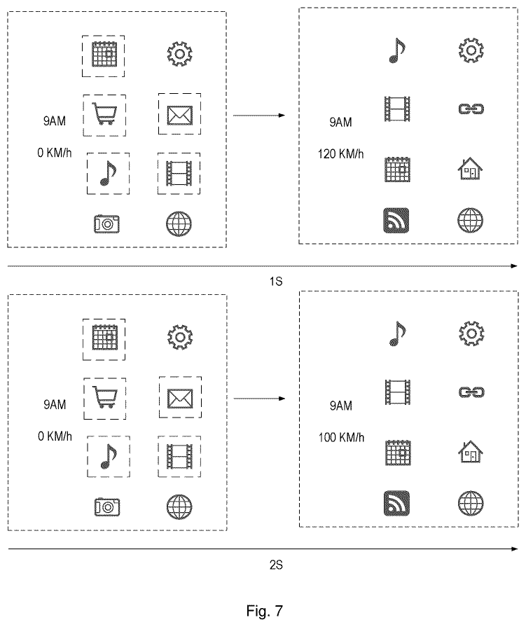

With reference to FIG. 7, FIG. 7 shows a schematic diagram when a vehicle-mounted terminal 106 switches icons. As shown in FIG. 7, in some embodiments, the frame rate of a switch animation may be related to scenario information. For instance, in some examples when the speed changes, the frame rate of the switch animation and the completion time of the switch may be different for different speeds after changing. For example, in FIG. 7, when the speed after the switch is 120 km/h, the frame rate of the switch animation may be greater than the frame rate of the switch animation when the speed after the switch is 100 km/h; therefore, the time for completing the switch is shorter than the time for completing the switch animation when the speed after the switch is 100 km/h. By associating the switch animation with the scenario information, the switch animation can be made more adaptable to the scenario.

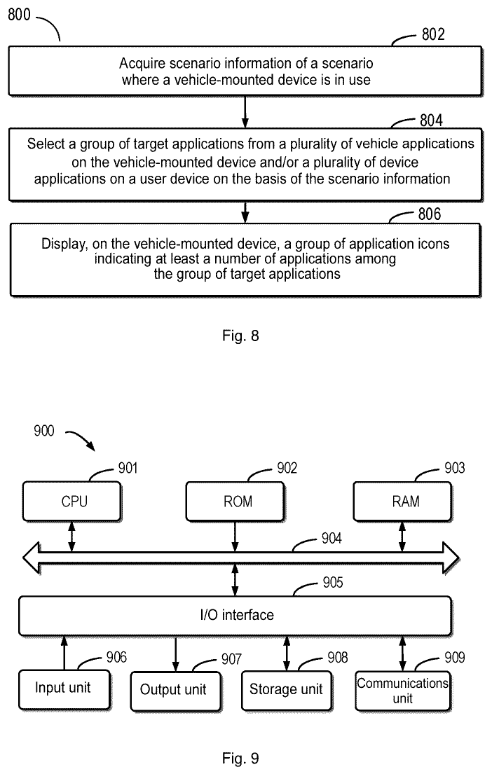

For ease of understanding, the present disclosure further provides a method for implementing icon display. Referring to FIG. 8, FIG. 8 shows a schematic flowchart of a method 800. At block 802, scenario information of a scenario where a vehicle-mounted device is in use is acquired. In some embodiments, the scenario information may refer to the current time and/or the current speed of a vehicle. For example, when a vehicle-mounted terminal 106 executes block 802, the vehicle-mounted terminal 106 may acquire the scenario information from a clock module and/or a speed meter module integrated in the vehicle.

At block 804, a group of target applications are selected from a plurality of vehicle applications on the vehicle-mounted device and/or a plurality of device applications on a user device on the basis of the scenario information. In some embodiments, the group of target applications adapted to a current scenario may be obtained on the basis of the scenario information by querying a predetermined mapping table. For example, when the vehicle-mounted terminal 106 executes block 804, the vehicle-mounted terminal 106 may query a predetermined mapping table on the basis of the current time and/or the current speed, and determine applications adapted to the current scenario from the vehicle applications and the mobile phone applications as the group of target applications. It can be understood that the group of target applications may be applications desired by a user in the current scenario. Alternatively, in other embodiments, the vehicle-mounted terminal 106 may also automatically determine the group of target applications on the basis of a method such as networking, and for a specific method, reference may be made to the foregoing description, which is not described herein.

In some embodiments, the group of target applications may also be selected on the basis of usage frequencies of the applications, the scenario information, and usage modes of the applications at the same time. For example, in some examples, the vehicle-mounted terminal 106 may first prioritize in overall the vehicle applications and the mobile phone applications on the basis of the usage frequencies of the vehicle applications and the mobile phone applications. Then, the vehicle-mounted terminal 106 may select the group of target applications by the method of re-ranking in FIG. 3 or the method of selecting on the basis of the scenario information and the usage modes without re-ranking in FIG. 4. For example, in some embodiments, the vehicle-mounted terminal 106 may perform re-ranking on the overall priority ranking 302 (i.e. adjusting the usage frequencies) on the basis of the weight corresponding to the scenario information and the usage modes to obtain re-ranked priorities 304. Subsequently, the vehicle-mounted terminal 106 may select the group of target applications on the basis of a precedence relationship between the priorities of the applications (i.e. a magnitude relationship between adjusted usage frequencies) after re-ranking. Moreover, in other embodiments, the vehicle-mounted terminal 106 may select candidate applications 406, 408, and 410 adapted to a current scenario on the basis of the scenario information and the usage modes of the applications, and then select, on the basis of a precedence relationship between the priorities of the candidate applications (i.e. a magnitude relationship between usage frequencies), candidate applications which have higher priorities and are frequently used by a user in daily life as the group of target applications.

In some embodiments, the usage mode of an application may be selected from a usage mode set, for example, the usage mode set may comprise a passive mode and an interactive mode, i.e. the usage mode of the application is a passive mode or an interactive mode. While in other embodiments, if the usage mode of an application is a target mode (for example, a passive mode), the usage mode of the application may further be subdivided into a usage sub-mode (for example, one of a semi-passive sub-mode and a fully-passive sub-mode). Therefore, in this embodiment, the usage modes of the applications are interactive mode, semi-passive sub-mode, or fully-passive sub-mode.

In some embodiments, the usage frequencies of the applications may be directly acquired, or the usage frequencies of the applications may also be obtained by normalizing the directly acquired initial usage frequencies. For example, in some embodiments, the vehicle-mounted terminal 106 may first acquire initial usage frequencies of the mobile phone applications from the mobile phone, and normalize the initial usage frequencies of the mobile phone applications and the initial usage frequencies of the vehicle applications to obtain the usage frequencies of the mobile phone applications and the vehicle applications. For specific description of normalization, reference may be made to the foregoing description, and details are not described herein again.

At block 806, a group of application icons for indicating at least a number of applications among the group of target applications is displayed on the vehicle-mounted device. It can be understood that, when the icons on the display apparatus can exist on only one display page and cannot be displayed on separate pages, application icons for indicating all these applications can be displayed on the display apparatus. If the icons on the display apparatus can be displayed on separate pages, the applications displayed on the current display page among these applications can be determined, and then the application icons of the applications are displayed. When the user switches the page, the application icons for indicating the remaining applications among these applications are displayed. For example, when the icons on the display apparatus can exist only on one display page, the vehicle-mounted terminal 106 may display application icons of all target applications on a display screen of the vehicle according to a certain law (for example, according to a priority precedence/magnitude of (adjusted) usage frequencies). When the icons on the display apparatus can be displayed on separate pages, the vehicle-mounted terminal 106 may allocate corresponding application icons for each display page of the display screen, and then the display screen displays only the corresponding application icons on the current display page. In some embodiments, attributes of the displayed application icons may be related to the scenario information. For instance, in some examples, the display size of the application icons may be proportional to the current speed. In addition, the display brightness of the application icons may be darker at night and brighter during the day. By associating the attributes of the application icons with the scenario information, the display effect may be more adaptable to a scenario, thereby improving the user experience.

When the scenario information changes, the selected target applications may change, and therefore the displayed application icons may also be switched to another group of application icons. Taking the display situation 108 in FIG. 1 as an example, when the speed changes from 0 km/h to 120 km/h, priorities of applications which do not require frequent interaction, such as music and videos, are increased, and new applications which are not selected as applications desired by the user in the scenario of 0 km/h are displayed, such that the group of icons displayed in the scenario of 9 AM and 0 km/h is switched to another group of icons corresponding to the scenario of 9 AM and 120 km/h. When the time changes from 9 AM to 9 PM, new applications which are not selected as applications desired by the user in the scenario of 9 AM are displayed, such that the group of icons displayed in the scenario of 9 AM and 120 km/h is switched to another group of icons corresponding to the scenario of 9 PM and 120 km/h. In the process of switching application icons, one group of application icons may be switched to another group of application icons on the basis of a switch animation. In some embodiments, the switch animation may be related to changed scenario information. For example, the faster the speed is, the higher the frame rate of the switch animation may be, such that the shorter the time for completing the switch is, the faster the switch is. By associating the switch animation with the scenario information, the switch animation can be made more adaptable to the scenario.

According to the embodiments of the present disclosure and the combined embodiments thereof described above, the efficiency of configuring the function and states can be improved. It should be understood that, the implementations illustrated in FIG. 1 to FIG. 8 are merely exemplary, and according to actual application situations, the architecture or process illustrated in FIG. 1 to FIG. 8 may have other different forms, and may further comprise more or less one or more functional modules and/or units, and these modules and/or units may be partially or completely implemented as hardware modules, software modules, firmware modules, or any combination thereof, which is not limited in the embodiments of the present disclosure.

It will be appreciated that the specific names of the various components of the systems and/or protocols described herein are merely intended to aid those skilled in the art in better understanding the concepts of the present disclosure and are not intended to limit the scope of the disclosure in any way. Moreover, in other embodiments, more or better components may be included, and alternate components having the same or similar functions may also be included.

FIG. 9 shows a schematic structural diagram of an exemplary device 900 which can be used to implement some embodiments according to the present disclosure. The device 900 may be implemented as a server or a PC, etc., and the embodiments of the present disclosure do not limit the specific implementation type of the device 900. As shown in FIG. 9, the device 900 comprises a Central Processing Unit (CPU) 901 which can perform various suitable actions and processes according to computer program instructions stored in a Read-Only Memory (ROM) 902 or computer program instructions loaded from a storage unit 908 into a Random Access Memory (RAM) 903. In the RAM 903, various programs and data necessary for the operation of the storage device 900 may also be stored. The CPU 901, the ROM 902, and the RAM 903 are connected to each other via a bus 904. An input/output (I/O) interface 905 is also connected to the bus 904.

A number of components in the device 900 are connected to the I/O interface 905, comprising: an input unit 906, such as a keyboard and a mouse; an output unit 907, such as various types of displays and speakers; a storage unit 908, such as a magnetic disk and an optical disk; and a communications unit 909, such as a network card, an update demodulator, and a wireless communications transceiver. The communications unit 909 allows the device 900 to exchange information/data with other devices via a computer network such as the Internet and/or various telecommunication networks.

The processing unit 901 can perform various methods and/or processes described above, such as the method illustrated in FIG. 8. For example, in some embodiments, the methods may be implemented as a computer software program tangibly embodied in a machine-readable medium, for example, the storage unit 908. In some embodiments, some or all of the computer programs can be loaded onto and/or installed onto the device 900 via the ROM 902 and/or the communications unit 909. When the computer programs are loaded into the RAM 903 and executed by the CPU 901, one or more steps of the methods described above can be performed. Alternatively, in other embodiments, the CPU 901 can be configured in any other suitable manner (e.g., by virtue of firmware or the like) to perform a method.

The functions described herein above can be performed, at least in part, by one or more hardware logic components. For example, without limitation, exemplary types of accessible hardware logic components include: Field-Programmable Gate Array (FPGA), Application-Specific Integrated Circuit (ASIC), Application-Specific Standard Product (ASSP), System-on-a-Chip (SOC), Complex Programmable Logic Device (CPLD), etc.

In some embodiments, the methods and processes described above may be implemented as a computer program product. The computer program product may comprise a computer-readable storage medium having computer-readable program instructions loaded thereon for executing various aspects of the present disclosure.

Program code for implementing the methods of the present disclosure may be written in any combination of one or more programming languages. These program code may be provided to a processor or controller of a general purpose computer, special purpose computer, or other programmable data processing apparatus, such that the program code, when executed by the processor or controller, causes the functions/operations specified in the flowchart and/or block diagrams to be performed. The program code may be executed entirely on the machine, partly on the machine, or as a stand-alone software package, partly on the machine and partly on the remote machine or entirely on the remote machine or server.

The computer-readable program instructions described herein may be downloaded to various computing/processing devices from a computer-readable storage medium or to external computers or external storage devices over a network, such as the Internet, a local area network, a wide area network, and/or a wireless network. The network may comprise copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in the computer-readable storage medium in the respective computing/processing device.

The computer program instructions for performing operations of the present disclosure may be assembly instructions, Instruction Set Architecture (ISA) instructions, machine instructions, machine related instructions, microcode, firmware instructions, state setting data, or source code or object code written in any combination of one or more programming languages, including an object-oriented programming language, and conventional procedural programming languages. The computer-readable program instructions may be executed entirely on the user computer, partly on the user computer, or as a stand-alone software package, partly on the user computer and partly on the remote computer, or entirely on the remote computer or server.

These computer-readable program instructions may be provided to a processing unit of a general purpose computer, special purpose computer, or other programmable data processing apparatus to produce a machine, such that the instructions, when executed by the processing unit of the general purpose computer or other programmable data processing apparatus, produce an apparatus for implementing the functions/actions specified in one or more blocks in the flowchart and/or the block diagram. These computer-readable program instructions may also be stored in a computer-readable storage medium, these instructions can cause a computer, a programmable data processing apparatus, and/or other devices to function in a particular manner, such that the computer-readable medium storing the instructions comprises an article of manufacture including instructions which implement various aspects of the functions/actions specified in one or more blocks in the flowchart and/or the block diagram. The computer-readable program instructions may also be loaded onto a computer, other programmable data processing apparatus, or other devices to cause a series of operation steps to be performed on the computer, other programmable apparatus or other devices to produce a computer implemented process, such that the instructions executed on the computer, other programmable apparatus or other devices implement the functions/actions specified in one or more blocks in the flowchart and/or the block diagram.

In the context of this disclosure, a machine-readable medium may be tangible media that may comprise or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a Random Access Memory (RAM), a Read-Only Memory (ROM), an Erasable Programmable Read-Only Memory (EPROM or Flash memory), an optical fiber, a portable Compact Disc Read-Only Memory (CD-ROM), an optical storage device, a magnetic storage device, or any suitable combination of the foregoing.

The flowchart and block diagram in the drawings illustrate the architecture, functions, and operations of possible implementations of devices, methods and computer program products according to various embodiments of the present disclosure. In this regard, each block in the flowchart or block diagram may represent a module, a program segment, or portion of an instruction, which includes one or more executable instructions for implementing the specified logical function(s). In some alternative implementations, the functions noted in the blocks may also occur out of the order noted in the drawings. For example, two blocks shown in succession may actually be executed substantially concurrently, or the blocks may sometimes be executed in the reverse order, depending on the functions involved. It should also be noted that each block in the block diagram and/or flowchart, and combinations of blocks in the block diagram and/or flowchart, may be implemented by special purpose hardware-based systems that perform the specified functions or actions, or by combinations of special purpose hardware and computer instructions.

In addition, while operations are depicted in a particular order, this should be understood as requiring such operations to be performed in the particular order shown or in a sequential order, or requiring all illustrated operations to be performed to achieve expected effects. In certain circumstances, multitasking and parallel processing may be advantageous. Likewise, while several specific implementation details are included in the above discussion, these should not be construed as limiting the scope of the disclosure. Certain features described in the information of individual embodiments may also be implemented in combination in a single implementation. Conversely, various features that are described in the information of a single implementation may also be implemented in multiple implementations separately or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely exemplary forms for implementing the claims.

Having described the embodiments of the present disclosure above, the foregoing description is exemplary, not exhaustive, and is not limited to the embodiments disclosed. Many modifications and variations will be apparent to those of ordinary skill in the art without departing from the scope and spirit of the illustrated embodiments. The choice of terms used herein is intended to best explain the principles of the embodiments, the practical application or technical improvement over technologies in the market, or to enable others of ordinary skill in the art to understand the embodiments disclosed herein.

1. A method for displaying application icons on a vehicle-mounted device, comprising:
acquiring scenario information of a scenario where the vehicle-mounted device is in use;
selecting a group of target applications from a plurality of vehicle applications on the vehicle-mounted device and/or a plurality of device applications on a user device on the basis of the scenario information, wherein the user device is connected to the vehicle-mounted device; and
displaying, on the vehicle-mounted device, a group of application icons indicating at least a number of applications among the group of target applications.

2. The method according to claim 1, wherein selecting a group of target applications comprises:
acquiring the usage frequency of each application among the plurality of vehicle applications and/or the plurality of device applications; and
selecting a group of target applications from the plurality of vehicle applications and/or the plurality of device applications on the basis of the usage frequency of each application, the scenario information, and a usage mode of each application among the plurality of vehicle applications and/or the plurality of device applications.

3. The method according to claim 2, wherein selecting a group of target applications from the plurality of vehicle applications and/or the plurality of device applications comprises:
adjusting the usage frequency of each application on the basis of the scenario information and the usage mode of each application; and
selecting a group of target applications from the plurality of vehicle applications and/or the plurality of device applications on the basis of a magnitude relationship between the adjusted usage frequencies of the applications.

4. The method according to claim 2, wherein selecting a group of target applications from the plurality of vehicle applications and/or the plurality of device applications comprises:
selecting a plurality of candidate applications from the plurality of vehicle applications and/or the plurality of device applications on the basis of the scenario information and the usage mode of each application; and
selecting a group of target applications from the plurality of candidate applications on the basis of a magnitude relationship between the usage frequencies of the plurality of candidate applications.

5. The method according to claim 2, further comprising:
determining a group of usage modes of the plurality of vehicle applications and/or the plurality of device applications from a usage mode set;
in response to the usage mode of some applications among the plurality of vehicle applications and/or the plurality of device applications in the group of usage modes being a target mode, determining usage sub-modes of said some applications from a usage sub-mode set corresponding to the target mode; and
updating the usage modes of said some applications from the target mode to the usage sub-modes, so as to obtain the usage mode of each application among the plurality of vehicle applications and/or the plurality of device applications.

6. The method according to claim 2, wherein acquiring the usage frequency of each application among the plurality of vehicle applications and/or the plurality of device applications comprises:
acquiring an initial usage frequency of each application among the plurality of vehicle applications and/or the plurality of device applications; and
adjusting the initial usage frequency of each application on the basis of the type of a device to which each application belongs, so as to obtain the usage frequency of each application among the plurality of vehicle applications and/or the plurality of device applications.

7. The method according to claim 1, wherein the scenario information comprises at least one of the speed of the vehicle-mounted device and the current time.

8. The method according to claim 1, further comprising:
in response to the scenario information changing to another piece of scenario information, switching the group of application icons which are being displayed to another group of application icons, wherein said another group of application icons is used for indicating at least a number of applications among another group of target applications corresponding to said another piece of scenario information.

9. The method according to claim 8, wherein switching the group of application icons to said another group of application icons comprises:
determining a switch animation corresponding to said another piece of scenario information; and
switching the group of application icons to said another group of application icons on the basis of the switch animation.

10. The method according to claim 1, wherein displaying the group of application icons comprises:
determining icon display attributes of the group of application icons on the basis of the scenario information; and
displaying the group of application icons on the vehicle-mounted device according to the icon display attributes.

11. An electronic device, comprising:
a processor, and
a memory coupled to the processor and storing instructions which, when executed by the processor, cause the device to execute the method according to claim 1.

12. A vehicle, comprising the electronic device according to claim 11.

13. A computer-readable storage medium, wherein the computer-readable storage medium stores computer-executable instructions which, when executed, cause a computer to execute the steps of the method according to claim 1.

14. A computer program product, wherein the computer program product is tangibly stored on a non-transitory computer-readable medium and comprises machine-executable instructions which, when executed, cause a machine to execute the steps of the method according to claim 1.
